(19) United States
(12) Patent Application Publication
(10) Pub. No.: US 2021/0065731 A1
(43) Pub. Date: Mar. 4, 2021

(54) NOISE CANCELLATION USING ARTIFICIAL INTELLIGENCE (AI)

(71) Applicant: Sony Interactive Entertainment Inc., Tokyo (JP)

(72) Inventors: Takeo Matsukawa, San Jose, CA (US); Jaekwon Yoo, Castro Valley, CA (US)

(21) Appl. No.: 16/556,215

(22) Filed: Aug. 29, 2019

(51) Int. Cl. G10L 21/0232; H04R 1/32; G10K 11/178; G06N 20/00

(52) U.S. Cl. CPC G10L 21/0232; H04R 1/326; G10L 2021/02082; G06N 20/00; G10K 11/17823

(57) ABSTRACT

A method includes receiving a signal that includes noise, generating a reference signal that comprises an estimate of the noise included in the received signal, and using the reference signal to remove at least part of the noise from the received signal. The reference signal is generated by a model built using machine learning. A system includes a first apparatus that carries a signal that includes noise, and a processor based apparatus configured to execute steps including receiving the signal that includes the noise, generating a reference signal that comprises an estimate of the noise included in the received signal, and using the reference signal to remove at least part of the noise from the received signal. A storage medium storing one or more computer programs is also provided.

### BACKGROUND OF THE INVENTION

### 1. Field of the Invention

Embodiments of the present invention relate generally to signal processing technology, and more specifically to noise cancellation and noise removal technologies.

### 2. Discussion of the Related Art

Signal processing is the process of analyzing and/or modifying a signal to produce a signal that is improved in some way or to extract information. One improvement that can be made to a signal is to reduce or eliminate the amount of noise that is in the signal. Noise cancellation, noise removal, noise suppression, and noise reduction are processes that are used to remove noise from a signal. Such processes can be used in numerous different applications and scenarios in which it is helpful and/or desirable to remove noise from a signal.

### SUMMARY OF THE INVENTION

One embodiment provides a method, comprising: receiving a signal that includes noise; generating a reference signal that comprises an estimate of the noise included in the received signal, wherein the reference signal is generated by a model built using machine learning; and using the reference signal to remove at least part of the noise from the received signal.

Another embodiment provides a system, comprising: a first apparatus that carries a signal that includes noise; and a processor based apparatus in communication with the first apparatus; wherein the processor based apparatus is configured to execute steps comprising: receiving the signal that includes the noise; generating a reference signal that comprises an estimate of the noise included in the received signal, wherein the reference signal is generated by a model built using machine learning; and using the reference signal to remove at least part of the noise from the received signal.

Another embodiment provides a non-transitory computer readable storage medium storing one or more computer programs configured to cause a processor based system to execute steps comprising: receiving a signal that includes noise; generating a reference signal that comprises an estimate of the noise included in the received signal, wherein the reference signal is generated by a model built using machine learning; and using the reference signal to remove at least part of the noise from the received signal.

A better understanding of the features and advantages of various embodiments of the present invention will be obtained by reference to the following detailed description and accompanying drawings which set forth an illustrative embodiment in which principles of embodiments of the invention are utilized.

### BRIEF DESCRIPTION OF THE DRAWINGS

The above and other aspects, features and advantages of embodiments of the present invention will be more apparent from the following more particular description thereof, presented in conjunction with the following drawings wherein:

FIG. 1 is a flow diagram illustrating a method in accordance with some embodiments of the present invention;

FIG. 2 is a block diagram illustrating a system that operates in accordance with some embodiments of the present invention;

FIG. 3A is a block diagram illustrating a deep learning architecture operating in a training phase in accordance with some embodiments of the present invention;

FIG. 3B is a block diagram illustrating an architecture operating in the actual use phase in accordance with some embodiments of the present invention; and

FIG. 4 is a block diagram illustrating a processor based apparatus/system that may be used to run, implement, and/or execute any of the methods, schemes, and techniques shown and described herein in accordance with some embodiments of the present invention.

### DETAILED DESCRIPTION

As mentioned above, noise cancellation, noise removal, noise suppression, and noise reduction are processes that are used to remove noise from a signal. The signal from which noise is to be removed will sometimes be referred to herein as the “subject signal”. The subject signal may comprise any signal which has been received, transmitted, sensed, detected, measured, generated, established, etc.

Many noise cancellation, noise removal, noise suppression, and noise reduction processes, techniques, and algorithms use a reference signal in order to remove noise from the subject signal. The reference signal is typically a known signal and often comprises a clean or relatively clean version of the target noise signal that is to be removed from the subject signal.

For example, acoustic echo cancellation (AEC) is a technique that implements a type of noise cancellation. It has traditionally been used for audio and involves recognizing the originally transmitted signal that re-appears as an echo in a received signal, and then removing the echo by subtracting it from the received signal. The received signal may be considered the subject signal from which noise (i.e. the echo) is to be removed. The echo is recognized and subtracted from the received (subject) signal by using the originally transmitted signal as a reference signal. That is, with AEC the originally transmitted signal typically comprises a clean version of the target noise signal that is to be removed. The AEC technique involves using the reference signal for comparing to, and subtracting from, the subject signal.

In many AEC implementations the originally transmitted signal is readily available for use as the reference signal. For example, in telephony and conference calling applications the signal carrying the far-end speaker's voice is typically readily available for use as the reference signal. That is, in many AEC implementations the echo is created because the microphone picks up the output of the audio speaker. Because the audio speaker is available and carries the originally transmitted signal, the AEC system knows what to cancel. As such, the AEC block receives the originally transmitted signal as one of its inputs.

But in many applications which use noise cancellation, noise removal, noise suppression, and noise reduction processes, techniques and algorithms, including some AEC implementations, the reference signal is either not available or is not easily obtained. Or, the reference signal may occasionally change and/or have different combinations, so it may not be known or easily calculated. In order to help solve these and other problems, some of the embodiments of the present invention provide methods, systems, and/or techniques that can be used to generate, create, and/or predict the reference signal.

Specifically, in some embodiments of the present invention the reference signal is generated using artificial intelligence (AI), such as for example machine learning. That is, in some embodiments, machine learning is used to generate, predict, or create the reference signal. The reference signal is then applied to the noise cancellation architecture to cancel out, remove, or reduce the noise. Thus, in some embodiments the present invention provides a combination of noise cancellation/source separation technology and machine learning or other type of AI.

In some embodiments, and as mentioned above, the reference signal may comprise a clean or relatively clean version of the target noise signal that is to be removed from the subject signal. As such, in some embodiments the target noise signal that is to be removed is generated using machine learning. That is, in some embodiments, instead of using machine learning to generate a clean version of the subject signal, machine learning is used to generate an estimate of the noise that is to be removed from the subject signal. Thus, in some embodiments, machine learning may be used to generate an estimate of the pure noise signal that is not wanted instead of a clean version of the subject signal. Once the unwanted noise signal is generated by machine leaning, it may then be used in a noise cancellation/source separation process, method, or technique to cancel, remove, reduce, or suppress the unwanted noise from the subject signal. For example, the unwanted noise signal may be used as a reference signal that is applied to any such noise cancellation process, method, or technique, such as for example AEC.

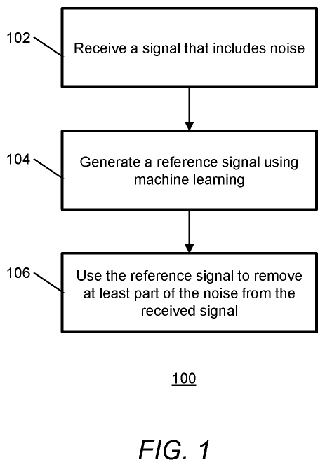

FIG. 1 illustrates a method 100 that operates in accordance with an embodiment of the present invention. In step 102 a signal is received that includes noise. In some embodiments, the received signal may be said to include a noise component. The received signal may be referred to as the “subject signal” since it comprises a signal from which the noise component is to be removed. By way of example, in some embodiments the received (subject) signal may comprise a microphone signal having an unwanted echo, a microphone signal having unwanted motor noise, a signal in a teleconferencing application having an unwanted echo, a signal in an electromagnetic tracking system having unwanted interference, or any other signal having unwanted noise and/or interference. The noise component may comprise any type of noise and/or interference, which will be discussed in more detail below.

In step 104 a reference signal is generated using machine learning or some other type of artificial intelligence (AI). In some embodiments, the reference signal comprises an estimate of the noise included in the received (subject) signal. That is, in some embodiments the reference signal comprises the target noise signal that is to be removed from the received signal. In some embodiments, the reference signal is generated by a model built using machine learning. Any type of machine learning may be used. For example, in some embodiments a generative adversarial network (GAN) may be used, that is, the model is built using GAN. In such embodiments, GAN is used to generate the reference signal, which may comprise the target noise signal that is to be removed. If the target noise signal that is to be removed comprises motor noise, then in such embodiments GAN is used to generate an estimate of the motor noise.

In step 106 the reference signal is used to remove at least part of the noise from the received signal. For example, the reference signal is used to cancel, remove, separate, suppress, and/or reduce the noise component in the received signal. In some embodiments all of the noise is removed, and in some embodiments at least part of the noise is removed. This step may be performed using any type of noise cancellation, noise reduction, and/or source separation process, technique, technology, method, algorithm, scheme, etc. That is, any noise cancellation process or algorithm can be used, and the teachings described herein can be applied to any noise cancellation process or algorithm. For example, in some embodiments AEC or a process or technique similar to AEC may be used. It should be well understood, however, that AEC is just one example and that any type of noise cancellation, noise suppression, and/or noise reduction process, technique, etc., may be used and that the use of AEC is not required.

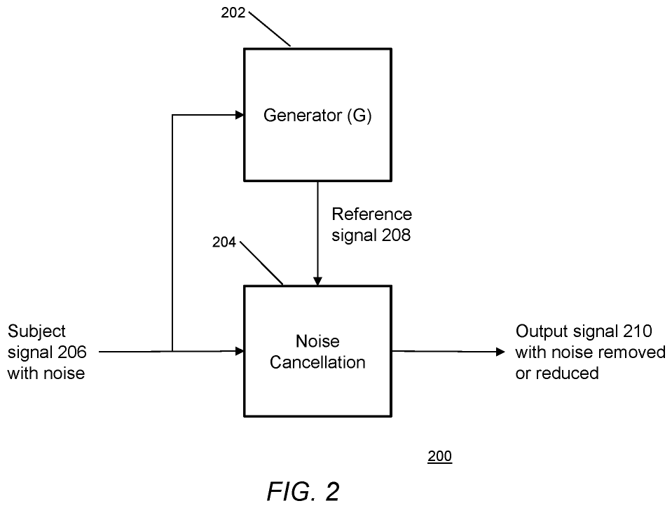

In some embodiments, the method 100 may be performed by a system such as the system 200 shown in FIG. 2. The system 200, which operates in accordance with an embodiment of the present invention, includes a generator (G) 202 and a noise cancellation block 204. During operation, in some embodiments, a subject signal 206 having a noise component is received by both the generator 202 and the noise cancellation block 204. The generator 202 generates a reference signal 208 based on machine learning. The noise cancellation block 204 uses the reference signal 208 to reduce, cancel, separate, suppress, and/or remove at least part of the noise component from the subject signal 206. As a result, the noise cancellation block 204 generates an output signal 210 having the noise component removed, cancelled, separated, suppressed, and/or reduced.

The generator 202 may implement any type of machine learning or other type of AI. As was mentioned above, any type of machine learning may be used, and in some embodiments a generative adversarial network (GAN) may be used. In such embodiments, GAN generates the reference signal, which in some embodiments may comprise the target noise signal to be removed. GAN generates the reference signal based on AI technology. In some embodiments, the generator 202 may comprise a combinational neural network (CNN) auto encoder and a recurrent neural network (RNN) auto encoder. It should be well understood, however, that GAN is just one example technology that may be used and that many other technologies may be used in accordance with some embodiments of the present invention.

The noise cancellation block 204 may perform or implement any type of noise cancellation, noise suppression, noise reduction, and/or source separation process, technique, technology, method, algorithm, scheme, etc. That is, any technologies or type of noise cancellation/source separation can be applied. For example, such technologies may include, but are not limited to, acoustic echo cancellation (AEC), source separation using deep learning, speech enhancement by nonnegative matrix factorization (NMF), etc. Many noise cancellation technologies involve subtracting the noise from the subject signal waveform.

As mentioned above, the noise component included in the subject signal may comprise any type of noise, distortion, and/or interference. For example, in some embodiments the noise component may comprise noise created by haptics or other electronics such as are found in computer gaming controllers and devices or other computer systems. Such haptics or other electronics may create motor sound noise, motor magnetic noise, fan noise, or any other type of noise. Motor sound noise can be difficult to remove and/or cancel because it can be broadband with a changing signal characteristic along time. The motor sound and signal can be recorded with a microphone closely located to the motor. In this case, however, other signals like music, speech, and other noises will also be recorded. As such, as described above, some embodiments of the present invention provide that the target noise signal to be removed is generated with machine learning, such as for example GAN. Then, using the generated signal from GAN, noise cancellation technologies (e.g. AEC, etc.) are applied to remove, cancel, suppress, or reduce it.

In some scenarios, the noise component included in the subject signal may comprise motor magnetic noise. Motor magnetic noise can be caused by the actuator, motor, and/or haptics. It can also be difficult to remove and/or cancel because it can be broadband but overlapped with the signal source and/or have changing signal characteristics along time and the drive signal. In accordance with some embodiments of the present invention, motor magnetic noise can be removed, reduced, and/or cancelled from the subject signal by using machine learning to generate an estimate of the motor magnetic noise, and then using the estimated motor magnetic noise as a reference signal with noise cancellation technologies to reduce, cancel, suppress, or remove it from the subject signal.

In some scenarios, the noise component included in the subject signal may comprise any other type of noise, such has for example fan noise, noise and/or interference caused by other nearby devices such as mobile phones, computer equipment, etc.

In some embodiments, the generator 202 generates the reference signal 208 by using a model that is built using machine learning. In order for the model to be effective it is first put through a training phase. More specifically, in some embodiments, the generator 202 has two phases of operation. There is a training phase, and then a test phase.

In the training phase the system has access to a sample of the real noise in clear condition. The system uses the sample of the real noise to train the model used by the generator 202 to generate the estimated noise. That is, the model is trained by using a sample of the real noise that is to be removed from the subject signal. For example, the model may be trained using a sample of motor noise, magnetic noise, fan noise, or whatever noise the particular application needs removed. The machine learning model, such as for example GAN, can be trained to generate any type of noise.

In contrast, in the test phase, which is the actual use phase, the system does not have access to a sample of the real noise. Instead, the system relies on the training of the model to accurately generate or predict the estimated noise, and then uses only the generated estimated noise. The estimated noise is used as the reference signal in the noise cancellation block 204.

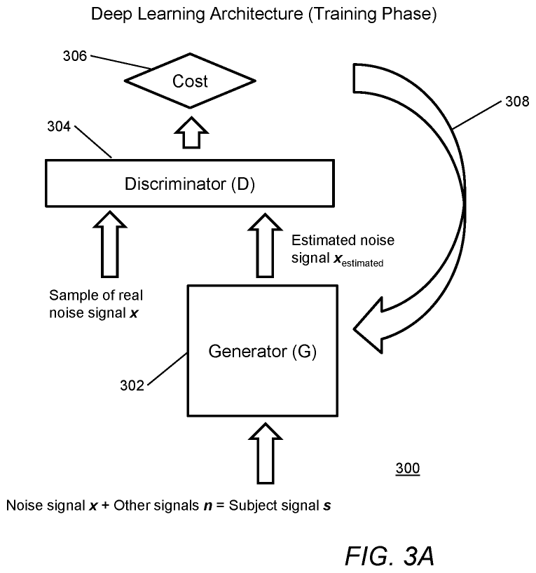

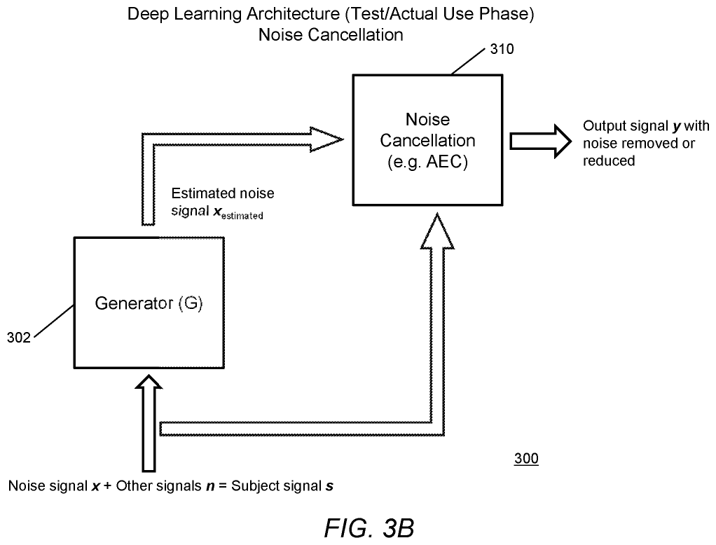

With respect to the training phase, in some embodiments, the model that is used by the generator 202 may be trained by using a deep learning architecture. FIG. 3A illustrates an example deep learning architecture 300 operating in the training phase in accordance with an embodiment of the present invention. As shown, the architecture 300 includes a generator (G) 302, a discriminator (D) 304, and a cost determination block 306. Similar to as described above, the generator 302 may use any type of machine learning or other type of AI. For example, in some embodiments GAN may be used, and in some embodiments it may comprise a CNN-auto encoder and an RNN-auto encoder. In some embodiments, the discriminator 304 and the cost determination block 306 are used only for the training phase.

In some embodiments, during the training phase of operation of the architecture 300, a subject signal s is received by the generator 302. The subject signal s includes noise that is to be removed. As discussed above, the subject signal s may comprise any signal having unwanted noise or interference, such as for example, a microphone signal having an unwanted echo, a microphone signal having unwanted motor noise, a signal in a teleconferencing application having an unwanted echo, a signal in an electromagnetic (EM) tracking system having unwanted interference, or the like.

The subject signal s may be represented by the following equation:

Subject signal s=noise signal x+other signals n

In this equation x represents the (real) noise signal that is unwanted and that is to be removed from the subject signal s. As described above, the noise signal x may comprise any type of noise, such as for example, motor sound noise, motor magnetic noise, fan noise, magnetic interference, etc. The other signals n represents all of the other signals included in the subject signal s. For example, the other signals n may include information carrying signal(s), other types of noise that do not need to be removed, and/or any other signals. Thus, by feeding the subject signal s into the generator 302 it can be said that everything (in terms of signals) is fed into the generator 302.

Next, the generator 302 generates an estimate of the noise signal x that is to be removed from the subject signal s, which is shown as the estimated noise signal x_{estimated}. As described above, in some embodiments the estimated noise signal x_{estimated} is generated by a model that is built using machine learning. Thus, after everything is fed into the generator 302, the generator 302 then generates an estimate of the noise that is to be removed. As described above, the estimated noise signal x_{estimated} can be used as a reference signal in a noise cancellation/source separation process, technique, technology, method, algorithm, scheme, etc.

The estimated noise signal x_{estimated}, which in some embodiments may also be referred to as the reference signal, is then provided to the discriminator 304. The other value that is provided to the discriminator 304 is the (real) noise signal x. In some embodiments, a sample of the (real) noise signal x may be obtained in order to provide it to the discriminator 304. In some embodiments, the sample of the (real) noise signal x should preferably be as pure as possible with no other signals so that the discriminator 304 knows what the real noise signal x looks and sounds like. As mentioned above, the system only has access to the sample of the real noise signal x during the training phase. That is, in some embodiments the training/learning phase is the only time the architecture 300 uses the discriminator 304 and has access to a sample of the real noise, such as a sample of the real motor noise, fan noise, magnetic interference, etc.

The discriminator 304 then compares the real noise signal x to the estimated noise signal x_{estimated}. The results of the comparison are provided to the cost determination block 306. In some embodiments, the cost determination block 306 determines how closely the estimated noise signal x_{estimated} matches the real noise signal x and whether or not it is an adequate estimate. The cost determination block 306 then provides feedback to the generator 302 via the feedback path 308. The feedback helps to improve the accuracy of the model used by the generator 302. That is, in some embodiments the cost determination block 306 and/or the discriminator 304 feeds back to the generator 302 to improve the model so that the generator 302 can try to make the estimate better. The model is adjusted and improved based on the feedback so it can more accurately generate and/or predict the estimated noise signal x_{estimated} to better match the real noise signal x. In this way the model, such as a GAN model, is trained to generate the estimated noise signal x_{estimated}.

In some embodiments, the cost determination block 306 simply assesses, considers, calculates, and/or determines the difference between the estimated noise signal x_{estimated} and the real noise signal x. In some embodiments, the cost determination block 306 provides a type of score or measure to the generator 302 via the feedback path 308 based on the difference between the estimated noise signal x_{estimated} and the real noise signal x.

In some embodiments, the cost determination block 306 may be configured for the specific type of noise cancellation process, method, or algorithm that is being used. For example, in some embodiments in which AEC will be used, the cost determination block 306 may perform the following cost function:

$${min}_{Y} {min}_{G} {max}_{D} V ( D , G ) = {𝔼}_{x ∼ {p}_{data} ( x )} [ log D ( x ) ] ++ {𝔼}_{z ∼ {p}_{z} ( z )} [ log ( 1 - D ( G ( z ) ) ) ] + {E [ y ]}^{2}$$

In this equation D represents the discriminator 304 and G represents the generator 302. In some embodiments, this cost function is specific to AEC. It should be well understood that the use of this cost function is certainly optional and that many other different types of cost functions and schemes may be used in the cost determination block 306.

In some embodiments, the training phase continues until the cost determination block 306 determines that the estimated noise signal x_{estimated} generated and/or predicted by the generator 302 adequately matches, estimates, and/or tracks the real noise signal x. In some embodiments, the estimated noise signal x_{estimated} does not have to exactly match or track the real noise signal x, it just needs to be close enough as determined by the discriminator 304 and the cost determination block 306. In some embodiments, when the estimated noise signal x_{estimated} is determined to be adequate, the model in the generator 302 is considered to be adequately trained, and the training phase is completed.

Thus, in some embodiments, the model is trained by generating the reference signal with the model and comparing the reference signal to a sample of the noise. The model is then adjusted based on the comparison of the reference signal to the sample of the noise.

As mentioned above, in some embodiments, the generator has two phases of operation, the second of which is the test phase. FIG. 3B illustrates an example of the deep learning architecture 300 operating in the test phase in accordance with an embodiment of the present invention. As shown, the discriminator 304 and the cost determination block 306 have been removed, and a noise cancellation block 310 has been added. As was mentioned above, in some embodiments the discriminator 304 and the cost determination block 306 are used only for the training phase. In some embodiments, in the test/actual use phase, the architecture 300 includes only the generator 302 and the noise cancellation block 310.

In some embodiments, the test phase comprises the actual use phase of the generator 302. That is, after training, the model is used to generate the target noise signal that is to be removed or canceled out using a noise cancellation type of function. During actual use, the architecture 300 does not have access to a sample of the real noise. Instead, the architecture 300 relies on the training of the model in the generator 302 to accurately generate the estimated noise, and then uses only the generated estimated noise for noise cancellation.

Thus, as illustrated, the subject signal s is received by both the generator 302 and the noise cancellation block 310. As discussed above, the subject signal s includes noise that is to be removed and may be represented by the equation: subject signal s=noise signal x+other signals n. The model in the generator 302 then generates an estimate of the noise signal x that is to be removed from the subject signal s, which is shown as the estimated noise signal x_{estimated}.

In some embodiments, the estimated noise signal x_{estimated} is then used as a reference signal in the noise cancellation block 310. The noise cancellation block 310 uses the estimated noise signal x_{estimated} to remove, reduce, suppress, and/or cancel the noise signal x from the subject signal s. That is, in some embodiments, the estimated noise signal x_{estimated} is used as a reference signal to remove at least part of the noise signal x from the subject signal s. Similar to as discussed above, the noise cancellation block 310 may perform or implement any type of noise reduction, noise cancellation, noise suppression, and/or source separation process, technique, technology, method, algorithm, scheme, etc. That is, any technologies or type of noise cancellation/source separation can be applied. The noise cancellation block 310 uses the estimated noise signal x_{estimated} to generate an output signal y having the noise signal x removed or reduced.

For example, in some embodiments, the noise cancellation block 310 may perform and/or implement AEC. In such a scenario, the subject signal s may comprise a microphone signal having an unwanted echo. By way of example, the echo may be created by the voice of a far-end speaker on a conference call, music playback, or other sounds picked up by the microphone. In order to remove the noise (i.e. the echo), the AEC algorithm may use an echo cancellation filter represented by h. In some embodiments, the noise cancellation block 310 may generate the output signal y according to the following equation:

y=s−h^{T}x_{estimated}

In this equation y=the output signal having the noise (i.e. the echo) removed or reduced, s=the microphone signal, and h=the echo cancellation filter. In some embodiments, this equation represents a transfer function to cancel the echo or other unwanted sounds picked up by the microphone.

In some embodiments, the microphone generates, produces, or creates the microphone signal s based on the sounds picked up by the microphone. As such, at least some portion of the microphone apparatus carries the microphone signal s. Thus, it can be said that the microphone comprises an apparatus that carries the microphone signal s. And because the microphone signal s comprises the subject signal s in this scenario, it can be said that the microphone comprises an apparatus that carries the subject signal s, i.e. a signal that includes noise.

Thus, some of the embodiments of the present invention provide techniques for noise cancellation, suppression, reduction, and/or removal by using a combination of noise cancellation/source separation technology and machine learning or other type of AI. In some embodiments, such techniques are useful in scenarios where a reference signal for noise cancellation is not available or easily obtained, such as when the real noise signal (e.g. an echo) is not available or easily obtained. In some embodiments, a machine learning training phase is used to train a model to learn the type of noise that is to be removed from a subject signal. The real noise, such as a sample of the real noise, is used during the training phase so that the model can learn to identify and predict the noise. After the training phase, the model is used in actual use (or a test phase) to generate an estimate of the noise to be removed, which is used as a reference signal in a noise cancellation, removal, suppression, reduction, and/or source separation process, technique, technology, method, algorithm, scheme, etc. Any kind or type of cancellation, removal, suppression, reduction, and/or source separation process, technique, etc., may be used to subtract, cancel, remove, suppress, and/or otherwise reduce the noise from the subject signal.

The teachings and techniques described herein may be used in numerous different applications and scenarios in which it is helpful and/or desirable to reduce, cancel, suppress, or remove noise from a signal. For example, in some embodiments, the teachings and techniques described herein may be used in applications involving teleconferencing or other voice or audio communication scenarios in which a microphone picks up unwanted sounds, such as an echo, other voices, music, motor noise, fan noise, etc. The teachings and techniques described herein can be used to generate an estimate of the unwanted sound, which can then be used to remove the unwanted sound from the subject signal.

As another example, in some embodiments, the teachings and techniques described herein may be used in applications involving positional tracking systems, such as those used to detect and track the position of a tangible object within three-dimensional space. Such positional tracking systems are often used by virtual reality (VR), augmented reality (AR), and mixed reality (MR) systems to track the positions of objects such as headsets, VR headsets, glasses-type user devices, head-mounted displays (HMD), etc., as well as one or more handheld controllers, wands, etc.

For example, an electromagnetic (EM) tracking system uses magnetic fields to track the position of an object by measuring the intensity of the magnetic fields. A transmitter TX generates a magnetic field, and a receiver RX, which is typically mounted in the object to be tracked, detects and measures the magnetic field strength. The measurements are used to calculate the position and orientation (PNO) of the object. But nearby electrical sources, such as haptics devices and motors inside hand-held controllers, can create magnetic interference in the generated magnetic fields, and even nearby metals, such as rebar in floors, can cause or create distortion in the generated magnetic fields, which can adversely affect the accuracy of EM tracking.

In some embodiments, the teachings and techniques described herein may be used to reduce, remove, and/or cancel the noise, interference, and/or distortion from the generated magnetic fields in an EM tracking system. For example, in some embodiments, a machine learning training phase is used to train a model (e.g. GAN) to learn the type of noise, interference, and/or distortion that is to be removed from the generated magnetic fields (i.e. the subject signal). Samples of the real noise, interference, and/or distortion, such as for example samples taken from haptics devices or distortion creating objects, are used during the training phase so that the model can learn to identify, predict, and/or generate the noise, interference, and/or distortion. For example, the model (e.g. GAN) can be trained to generate magnetic interference signals. After the training phase, the model is used in actual use to predict and/or generate an estimate of the noise, interference, and/or distortion to be removed, which is then used as a reference signal in a noise cancellation, removal, suppression, reduction, and/or source separation process, technique, technology, method, algorithm, scheme, etc. The noise cancellation, removal, suppression, reduction, and/or source separation can be applied at the EM tracking system receiver to the magnetic fields detected and received by the EM tracking system receiver. This results in the noise, interference, and/or distortion being subtracted, reduced, canceled, suppressed, and/or removed from the received magnetic fields (i.e. the subject signal). This can result in improved accuracy of the EM tracking system.

In some embodiments, if the noise cancellation, removal, suppression, reduction, and/or source separation is applied at the EM tracking system receiver to the magnetic fields that it detects and receives, then at least some portion of the EM tracking system receiver apparatus carries the received magnetic fields. Thus, it can be said that the EM tracking system receiver comprises an apparatus that carries the received magnetic fields. And because the received magnetic fields comprise the subject signal in this scenario, it can be said that the EM tracking system receiver comprises an apparatus that carries the subject signal, i.e. a signal that includes noise.

In some embodiments, the above-described teachings and techniques can be applied to other types of positional tracking systems, such as inertial tracking systems which use inertial sensors, as well as optical tracking systems which use cameras or other image capture devices. In some embodiments, the above-described teachings and techniques can be applied to communications devices and technologies, such as radio frequency (RF) antennas, to remove, cancel, suppress, and/or reduce noise in received and/or transmitted signals.

In some embodiments, the methods, schemes, and techniques described herein may be utilized, implemented and/or run on many different types of processor based apparatuses or systems. For example, the methods, schemes, and techniques described herein may be utilized, implemented, and/or run in any type of system, device, apparatus, etc., in which noise cancellation, suppression, reduction, and/or removal is desired, and any such systems may be implemented on communications systems or equipment, positional tracking systems, smartphones, game consoles, entertainment systems, portable devices, mobile devices, pad-like devices, computers, workstations, desktop computers, notebook computers, servers, etc. Furthermore, in some embodiments the methods, schemes, and techniques described herein may be utilized, implemented and/or run in online scenarios, networked scenarios, over the Internet, etc.

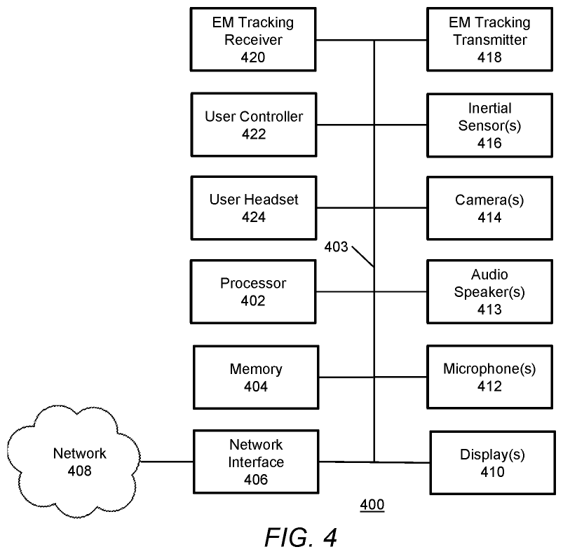

Referring to FIG. 4, there is illustrated an example of a processor based system or apparatus 400 that may be used for any such implementations. The system or apparatus 400 may be used for implementing any method, scheme, technique, system, or device mentioned above. However, the use of the system or apparatus 400 or any portion thereof is certainly not required.

By way of example, the processor based system 400 may include, but is not required to include, a processor 402 (e.g. a central processing unit (CPU)), a memory 404, a wireless and/or wired network interface 406, access to a network 408, one or more displays 410, one or more microphones 412, one or more audio speakers 413, one or more cameras or other image capture devices 414, one or more inertial sensors 416, an electromagnetic (EM) tracking transmitter 418, an EM tracking receiver 420, a user controller 422, and a user headset 424. One or more of these components may be collected together in one apparatus, device, or system, or the various components may be distributed across one or more different apparatuses, devices, or systems, or even distributed across one or more networks. In some embodiments, one or more of these components may be collected together in one or more embedded systems. In some embodiments, one or more of these components, but not necessarily all of the components, may be considered and referred to as a processor based apparatus or system. In some embodiments, the use or inclusion of any of the components is optional. In some embodiments, the components communicate with each other via connections and/or communications channels 403, which may comprise wired connections, wireless connections, network connections, or a mixture or combination of both wired and wireless connections, communications channels, network connections, buses, etc.

The processor 402 may be used to execute or assist in executing the steps of the methods, schemes, and techniques described herein, and various program content, images, video, overlays, UIs, assets, virtual worlds, menus, menu screens, interfaces, graphical user interfaces (GUIs), windows, tables, graphics, avatars, characters, players, video games, simulations, etc., may be rendered on the display(s) 410. In some embodiments, the processor 402 executes code, software, or steps that implements the AI, machine learning, models, GAN, CNN-auto encoder, RNN-auto encoder, noise cancellation and/or noise removal blocks, AEC, generators, discriminators, cost determination blocks, etc., described above.

The one or more displays 410 may comprises any type of display devices and may be used for implementing any needed environments. For example, in some embodiments one or more displays 410 may be included in a head worn device such as a headset, glasses-type user device, head-mounted display (HMD), or the like. In some embodiments the one or more displays 410 may be included or associated with any type of VR device, AR device, or MR device. In some embodiments a display may be included in a device such as a smartphone, tablet computer, pad-like computer, notebook computer, etc. In some embodiments the one or more displays 410 may be associated with any type of computer such as desktop computers, etc. The one or more displays 410 may comprise any type of display or display device or apparatus, using any type of display technology.

The memory 404 may include or comprise any type of computer readable storage or recording medium or media. In some embodiments, the memory 404 may include or comprise a tangible, physical memory. In some embodiments, the memory 404 may be used for storing program or computer code or macros that implements the methods and techniques described herein, such as program code for running the methods, schemes, and techniques described herein. In some embodiments, the memory 404 may serve as a tangible non-transitory computer readable storage medium for storing or embodying one or more computer programs or software applications for causing a processor based apparatus or system to execute or perform the steps of any of the methods, code, schemes, and/or techniques described herein. Furthermore, in some embodiments, the memory 404 may be used for storing any needed database(s).

In some embodiments, the wireless and/or wired network interface 406 may be used for accessing the network 408 for obtaining any type of information, such as for example any information needed for implementing or running the AI, machine learning, GAN, noise cancellation, etc., technologies discussed herein. The network 408 may comprise the Internet, a local area network, an intranet, a wide area network, or any other network.

The one or more microphones 412 may comprise any type of microphones. In some embodiments, the one or more microphones 412 may be used for implementing or performing any of the noise cancellation scenarios or techniques discussed above, such as for example any of the AEC scenarios discussed above. In some embodiments, the one or more microphones 412 may be located or positioned on a user's headset, glasses-type user device, HMD, or elsewhere in an VR, AR, or MR environment or room. In some embodiments, the one or more microphones 412 may be included or associated with a device such as a smartphone, tablet computer, pad-like computer, notebook computer, desktop computer, communications device or equipment, etc.

The one or more audio speakers 413 may comprise any type of audio speakers. In some embodiments, the one or more audio speakers 413 may be used for implementing any of the noise cancellation scenarios or techniques discussed above, such as for example any of the AEC scenarios discussed above. In some embodiments, the one or more audio speakers 413 may be located, positioned, included, or associated with any device or equipment, such as for example any VR, AR, or MR system, smartphone, tablet computer, pad-like computer, notebook computer, desktop computer, communications device or equipment, etc.

The one or more cameras or other image capture devices 414 may comprise any type of cameras or image capture devices. In some embodiments, the one or more cameras 414 may be used for implementing and/or enabling an optical tracking system, optical tracking component, and/or optical tracking technology. As such, in some embodiments, the one or more cameras 414 comprises an apparatus that is used for tracking a tangible object as described above. In some embodiments, the one or more cameras 414 may be used for identifying, recognizing, and/or determining the geometry, form factor, size, location, and/or position of tangible objects, and/or for detecting intersections of various geometries. In some embodiments, the one or more cameras 414 may comprise depth cameras, depth sensing cameras, stereo cameras, or any other type of camera or image capture device. In some embodiments, the one or more cameras 414 may be located or positioned on a user's headset, glasses-type user device, HMD, or elsewhere in an VR, AR, or MR environment or room. In some embodiments, the one or more cameras 414 may be included or associated with a device such as a smartphone, tablet computer, pad-like computer, notebook computer, desktop computer, etc.

The one or more inertial sensors 416 may comprise any type of inertial sensors or devices, such as for example inertial measurement units (IMU), accelerometers, gyroscopes, and the like. In some embodiments, the one or more inertial sensors 416 may be used for implementing and/or enabling an inertial tracking system, inertial tracking component, and/or inertial tracking technology. As such, in some embodiments, the one or more inertial sensors 416 comprises an apparatus that is used for tracking a tangible object as described above. In some embodiments, the one or more inertial sensors 416 may be located or positioned in a handheld controller, user interface (UI) controller, game pad, wand, or similar device, and/or on a user's headset, glasses-type user device, HMD, or elsewhere in an VR, AR, or MR environment or room. In some embodiments, the one or more inertial sensors 416 may be included or associated with a device such as a smartphone, tablet computer, pad-like computer, notebook computer, desktop computer, etc. In some embodiments, the one or more inertial sensors 416 may comprise any type of sensors for sensing, determining, and/or tracking the movements, position, and/or motions of a user and/or a tangible object.

The EM tracking transmitter 418 and EM tracking receiver 420 may comprise any type of transmitter and receiver suitable for use with an EM tracking system. In some embodiments, the EM tracking transmitter 418 and EM tracking receiver 420 may be used for implementing and/or enabling an EM tracking system, EM tracking component, and/or EM tracking technology as discussed above. As such, in some embodiments, the EM tracking transmitter 418 and EM tracking receiver 420 comprise apparatuses that are used for tracking a tangible object as described above. In some embodiments, the EM tracking transmitter 418 may be included in or attached to a user headset, such as for example an HMD, glasses-type user device, or similar device. In some embodiments, the EM tracking receiver 420 may be included in or attached to a handheld controller, UI controller, game pad, wand, or similar device. It should be well understood, however, that in some embodiments the locations of the EM tracking transmitter 418 and the EM tracking receiver 420 may be reversed, i.e. the EM tracking transmitter 418 included in or attached to a handheld controller, UI controller, etc., and the EM tracking receiver 420 included in or attached to a user headset, HMD, etc. Furthermore, in some embodiments the EM tracking transmitter 418 and the EM tracking receiver 420 may be located elsewhere as appropriate for the particular application.

The user controller 422 may comprise any type of controller, such as for example a handheld controller, UI controller, game pad, game controller, wand, or similar device. In some embodiments, the user controller 422 may include one or more of any of the components described above, such as for example inertial sensor(s), EM tracking transmitter(s), EM tracking receiver(s), microphone(s), audio speaker(s), and/or camera(s). Furthermore, in some embodiments, the user controller 422 may include any potential noise, interference, and/or distortion creating or emitting devices or components as described above, such as for example haptics devices, motors, vibration or motion devices, fans, transmitters, receivers, sensors, networking devices, certain types of metals or materials, magnetic devices, or other electronics or systems. In some embodiments, any such noise, interference, and/or distortion created or emitted by such devices or components may be canceled, removed, reduced, or suppressed from a subject signal using any of the methods and techniques described herein.

The user headset 424 may comprise any type of head worn device, apparatus, or object, such as for example glasses-type user devices, head-mounted displays (HMD), any type of VR, AR, and/or MR head worn device, etc. In some embodiments, the user headset 424 may include one or more of any of the displays mentioned or described herein. In some embodiments, the user headset 424 may include one or more of any of the components described above, such as for example microphone(s), audio speaker(s), camera(s), inertial sensor(s), EM tracking transmitter(s), and/or EM tracking receiver(s). And similar to the user controller 422, in some embodiments the user headset 424 may include any potential noise, interference, and/or distortion creating or emitting devices or components, such as for example haptics devices, motors, vibration or motion devices, fans, transmitters, receivers, sensors, networking devices, certain types of metals or materials, magnetic devices, or other electronics or systems. In some embodiments, any such noise, interference, and/or distortion created or emitted by such devices or components may be canceled, removed, reduced, or suppressed from a subject signal using any of the methods and techniques described herein.

In some embodiments, any potential noise, interference, and/or distortion creating or emitting devices or components, such as any of those mentioned above, may be included or located anywhere within or nearby the system or apparatus 400. Additional noise, interference, and/or distortion creating or emitting devices that may be located nearby may include, for example, mobile communication devices, cell phones, one or more additional user controllers, and/or other similar devices. Any such devices or components may adversely affect the signals generated, received, or processed by any of the components included in the system or apparatus 400. Similar to above, in some embodiments, any such noise, interference, and/or distortion created or emitted by such devices or components may be canceled, removed, reduced, or suppressed from any subject signal using any of the methods and techniques described herein.

In some embodiments, one or more of the embodiments, methods, approaches, schemes, and/or techniques described above may be implemented in one or more computer programs or software applications executable by a processor based apparatus or system. By way of example, such processor based system may comprise a smartphone, tablet computer, VR, AR, or MR system, entertainment system, game console, mobile device, computer, workstation, desktop computer, notebook computer, server, graphics workstation, client, portable device, pad-like device, communications device or equipment, etc. Such computer program(s) or software may be used for executing various steps and/or features of the above-described methods, schemes, and/or techniques. That is, the computer program(s) or software may be adapted or configured to cause or configure a processor based apparatus or system to execute and achieve the functions described herein. For example, such computer program(s) or software may be used for implementing any embodiment of the above-described methods, steps, techniques, schemes, or features. As another example, such computer program(s) or software may be used for implementing any type of tool or similar utility that uses any one or more of the above described embodiments, methods, approaches, schemes, and/or techniques. In some embodiments, one or more such computer programs or software may comprise a VR, AR, or MR application, communications application, object positional tracking application, a tool, utility, application, computer simulation, computer game, video game, role-playing game (RPG), other computer simulation, or system software such as an operating system, BIOS, macro, or other utility. In some embodiments, program code macros, modules, loops, subroutines, calls, etc., within or without the computer program(s) may be used for executing various steps and/or features of the above-described methods, schemes and/or techniques. In some embodiments, such computer program(s) or software may be stored or embodied in a non-transitory computer readable storage or recording medium or media, such as a tangible computer readable storage or recording medium or media. In some embodiments, such computer program(s) or software may be stored or embodied in transitory computer readable storage or recording medium or media, such as in one or more transitory forms of signal transmission (for example, a propagating electrical or electromagnetic signal).

Therefore, in some embodiments the present invention provides a computer program product comprising a medium for embodying a computer program for input to a computer and a computer program embodied in the medium for causing the computer to perform or execute steps comprising any one or more of the steps involved in any one or more of the embodiments, methods, approaches, schemes, and/or techniques described herein. For example, in some embodiments the present invention provides one or more non-transitory computer readable storage mediums storing one or more computer programs adapted or configured to cause a processor based apparatus or system to execute steps comprising: receiving a signal that includes noise; generating a reference signal that comprises an estimate of the noise included in the received signal, wherein the reference signal is generated by a model built using machine learning; and using the reference signal to remove at least part of the noise from the received signal.

While the invention herein disclosed has been described by means of specific embodiments and applications thereof, numerous modifications and variations could be made thereto by those skilled in the art without departing from the scope of the invention set forth in the claims.

What is claimed is:

1. A method, comprising:
receiving a signal that includes noise;
generating a reference signal that comprises an estimate of the noise included in the received signal, wherein the reference signal is generated by a model built using machine learning; and
using the reference signal to remove at least part of the noise from the received signal.

2. The method of claim 1, wherein the model built using machine learning comprises a model built using a generative adversarial network (GAN).

3. The method of claim 1, wherein the using the reference signal to remove at least part of the noise from the received signal comprises:
using the reference signal in a noise cancellation process.

4. The method of claim 1, wherein the using the reference signal to remove at least part of the noise from the received signal comprises:
using the reference signal in an acoustic echo cancellation (AEC) process.

5. The method of claim 1, further comprising:
training the model by generating the reference signal with the model and comparing the reference signal to a sample of the noise.

6. The method of claim 5, wherein the training the model further comprises:
adjusting the model based on the comparison of the reference signal to the sample of the noise.

7. A system, comprising:
a first apparatus that carries a signal that includes noise; and
a processor based apparatus in communication with the first apparatus;
wherein the processor based apparatus is configured to execute steps comprising:
receiving the signal that includes the noise;
generating a reference signal that comprises an estimate of the noise included in the received signal, wherein the reference signal is generated by a model built using machine learning; and
using the reference signal to remove at least part of the noise from the received signal.

8. The system of claim 7, wherein the first apparatus comprises a microphone.

9. The system of claim 7, wherein the first apparatus comprises an apparatus used for tracking a tangible object.

10. The system of claim 7, wherein the model built using machine learning comprises a model built using a generative adversarial network (GAN).

11. The system of claim 7, wherein the using the reference signal to remove at least part of the noise from the received signal comprises:
using the reference signal in a noise cancellation process.

12. The system of claim 7, wherein the using the reference signal to remove at least part of the noise from the received signal comprises:
using the reference signal in an acoustic echo cancellation (AEC) process.

13. The system of claim 7, wherein the processor based apparatus is further configured to execute steps comprising:
training the model by generating the reference signal with the model and comparing the reference signal to a sample of the noise.

14. The system of claim 13, wherein the training the model further comprises:
adjusting the model based on the comparison of the reference signal to the sample of the noise.

15. A non-transitory computer readable storage medium storing one or more computer programs configured to cause a processor based system to execute steps comprising:
receiving a signal that includes noise;
generating a reference signal that comprises an estimate of the noise included in the received signal, wherein the reference signal is generated by a model built using machine learning; and
using the reference signal to remove at least part of the noise from the received signal.

16. The non-transitory computer readable storage medium of claim 15, wherein the model built using machine learning comprises a model built using a generative adversarial network (GAN).

17. The non-transitory computer readable storage medium of claim 15, wherein the using the reference signal to remove at least part of the noise from the received signal comprises:
using the reference signal in a noise cancellation process.

18. The non-transitory computer readable storage medium of claim 15, wherein the using the reference signal to remove at least part of the noise from the received signal comprises:
using the reference signal in an acoustic echo cancellation (AEC) process.

19. The non-transitory computer readable storage medium of claim 15, wherein the one or more computer programs are further configured to cause the processor based system to execute steps comprising:
training the model by generating the reference signal with the model and comparing the reference signal to a sample of the noise.

20. The non-transitory computer readable storage medium of claim 19, wherein the training the model further comprises:
adjusting the model based on the comparison of the reference signal to the sample of the noise.
